(19) United States
(12) Patent Application Publication
(10) Pub. No.: US 2012/0194470 A1
(43) Pub. Date: Aug. 2, 2012

(54) CAPACITIVE TOUCH PANEL AND COORDINATE DETECTING METHOD THEREOF

(75) Inventor: Chien-Hung Yu, Taipei City (TW)

(73) Assignee: I-MOBILE TECHNOLOGY CORP., Taipei City (TW)

(21) Appl. No.: 13/352,444

(22) Filed: Jan. 18, 2012

(30) Foreign Application Priority Data
Jan. 27, 2011 (TW) 100102980

(51) Int. Cl. G06F 3/044

(52) U.S. Cl. 345/174

(57) ABSTRACT

The invention discloses a capacitive touch panel and a coordinate detecting method thereof. The capacitive touch panel according to the invention includes N first electrodes extending along a first direction, M second electrodes extending along a second direction non-parallel with the first direction, and a controlling/processing device, where N and M respectively are an integer larger than 1. In particular, the controlling/processing device simultaneously outputs a frequency signal to each of the first electrodes, simultaneously outputs another frequency signal to each of the second electrodes, and monitors a respective third frequency signal outputted by each first electrode and a respective fourth frequency signal outputted by each second electrode. Moreover, the controlling/processing device judges at least one touch coordinate in accordance with the monitored third frequency signals and the monitored fourth frequency signals.

### CROSS-REFERENCE TO RELATED APPLICATION

This utility application claims priority to Taiwan Application Serial Number 100102980, filed Jan. 27, 2011, which is incorporated herein by reference.

### BACKGROUND OF THE INVENTION

1. Field of the Invention

The invention relates to capacitive touch panel and coordinate detecting method thereof. Moreover, in particular, the capacitive touch panel according to the invention has advantages of simplified circuit, rapid response, availability for a variety of sizes of panel, etc.

2. Description of the Prior Art

Since touch screens have the advantage of enabling operators to intuitively input coordinate relative to the display device in touch way, touch screens have become popular input apparatuses equipped by modern display devices. Touch screens have been widely applied to various electronic products having display devices, such as monitors, laptop computers, tablet computers, automated teller machines (ATM), point of sale (POS), tourist guiding systems, industrial control systems, mobile phones, and so on.

Based on difference of structure and sensing way, current touch panels enable touch screens to be touch-inputted are roughly classified into resistive touch screens, capacitive touch screens, ultrasonic touch screens, optical touch screens, etc. In addition, in past when detects only single touch coordinate, the touch panels have been developed to detect multi-touch coordinates.

Referring to FIG. 1, FIG. 1 illustratively shows the architecture of a conventional capacitive touch panel 1.

As shown in FIG. 1, the capacitive touch panel 1 according to the invention includes a dielectric base 10, N first electrodes (X1˜Xn), M second electrodes (Y1˜Ym), a touch detecting circuit 16, and a controlling/processing device 18, where N and M respectively are an integer larger than 1.

The N first electrodes (X1˜Xn) are formed on a first surface 12 of the dielectric base 10, and extend along a first direction. The M second electrodes (Y1˜Ym) are formed on a second surface 14 of the dielectric base 10 opposite to the first surface 12, and extend along a second direction non-parallel with the first direction. For example, as shown in FIG. 1, the M second electrodes (Y1˜Ym), extending along the second direction, are perpendicular to the N first electrodes (X1˜Xn) extending along the first direction.

Also as shown in FIG. 1, the touch detecting circuit 16 is respectively electrically connected to a respective end of each first electrode (X1˜Xn) and to a respective end of each second electrode (Y1˜Ym). The touch detecting circuit 16 is also electrically connected to the controlling/processing device 18. The touch detecting circuit 16 is controlled by the controlling/processing device 18 to scan the first electrodes (X1˜Xn) and the second electrodes, and further to judge the coordinates of touch points.

Obviously, the conventional capacitive touch panel 1 utilizes serial signal processing; therefore, the response of touch detected by the capacitive touch panel 2 is not rapid enough. The conventional capacitive touch panel 1 could generate ghost touch points, and obtains actual touch points necessarily by consumption of computation resources to prevent ghost touch points possibly generated. The size of conventional capacitive touch panel 1 is limited by the number of scanning pin offered by the controlling/processing device 18, and the number of scanning pin is limited by the process capacity of the controlling/processing device 18. In addition, based on the architecture of the capacitive touch panel, the conventional capacitive touch panel 1 must be charged, so the problem of failing to detect positions relative to tail ends of the electrodes could occur.

The larger the size of conventional capacitive touch panels increases, the more difficult aforesaid problems are to overcome.

### SUMMARY OF THE INVENTION

Accordingly, one scope of the invention is to provide a capacitive touch panel and coordinate detecting method thereof. The capacitive touch panel according to the invention has advantages of simplified circuit, rapid response, availability for a variety of sizes of panel, etc.

A capacitive touch panel according to a preferred embodiment of the invention includes a dielectric base, N first electrodes, M second electrodes and a controlling/processing device, where N and M respectively are an integer larger than 1. The N first electrodes are formed on a first surface of the dielectric base, and extend along a first direction. The M second electrodes are formed on a second surface of the dielectric base opposite to the first surface, and extend along a second direction non-parallel with the first direction. The controlling/processing device is respectively electrically connected to a respective end of each first electrode and to a respective end of each second electrode. The controlling/processing device is for simultaneously outputting a first frequency signal to each first electrode, and simultaneously outputting a second frequency signal to each second electrode. The controlling/processing device also monitors a respective third frequency signal outputted by each first electrode and a respective fourth frequency signal outputted by each second electrode. The controlling/processing device also judges at least one touch coordinate in accordance with the monitored third frequency signals and the monitored fourth frequency signals.

In one embodiment, the controlling/processing device monitors a respective first discharge period relative to each third frequency signal and a respective second discharge period relative to each fourth frequency signal. The controlling/processing device also judges the at least one touch coordinate in accordance with the monitored first discharge periods and the monitored second discharge periods.

In one embodiment, the controlling/processing device includes a complex programmable logic device (CPLD) or a micro-control unit (MCU).

In one embodiment, the dielectric base is formed of a glass, an acrylic or other commercial transparent and dielectric material.

A coordinate detecting method according to a preferred embodiment of the invention is applied in a capacitive touch panel. The capacitive touch panel includes a dielectric base, N first electrodes and M second electrodes, where N and M respectively are an integer larger than 1. The N first electrodes are formed on a first surface of the dielectric base, and extend along a first direction. The M second electrodes are formed on a second surface of the dielectric base opposite to the first surface and extending along a second direction non-parallel with the first direction. The coordinate detecting method is, firstly, to simultaneously output a first frequency signal to each first electrode, and to simultaneously output a second frequency signal to each second electrode. Next, the coordinate detecting method is to monitor a respective third frequency signal outputted by each first electrode and a respective fourth frequency signal outputted by each second electrode. Finally, the coordinate detecting method is to judge at least one touch coordinate in accordance with the monitored third frequency signals and the monitored fourth frequency signals.

The advantage and spirit of the invention may be understood by the following recitations together with the appended drawings.

### BRIEF DESCRIPTION OF THE APPENDED DRAWINGS

FIG. 1 is a schematic diagram showing the architecture of a conventional capacitive touch panel.

FIG. 2 is a schematic diagram showing the architecture of a capacitive touch panel according to a preferred embodiment of the invention.

FIG. 3A is a diagram showing the monitored frequency signals outputted by electrodes of the capacitive touch panel applied by the invention under non-touch.

FIG. 3B is a diagram showing the monitored frequency signals outputted by electrodes of the capacitive touch panel applied by the invention under single touch.

FIG. 4 is a flow diagram illustrating a coordinate detecting method according to a preferred embodiment of the invention.

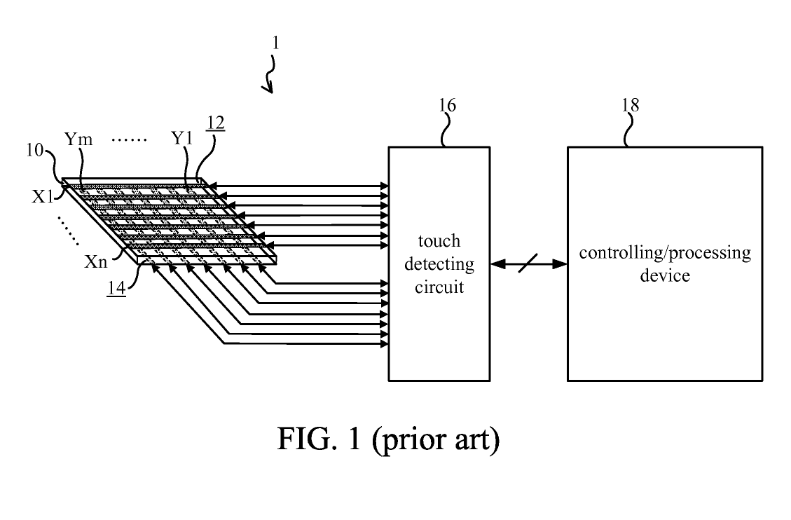

### DETAILED DESCRIPTION OF THE INVENTION

The invention is to provide a capacitive touch panel and coordinate detecting method thereof. In particular, the capacitive touch panel according to the invention has advantages of simplified circuit, rapid response, availability for a variety of sizes of panel, etc. Some preferred embodiments and practical applications of this present invention would be explained in the following paragraph, describing the characteristics, spirit, advantages of the invention, and feasibility of embodiment.

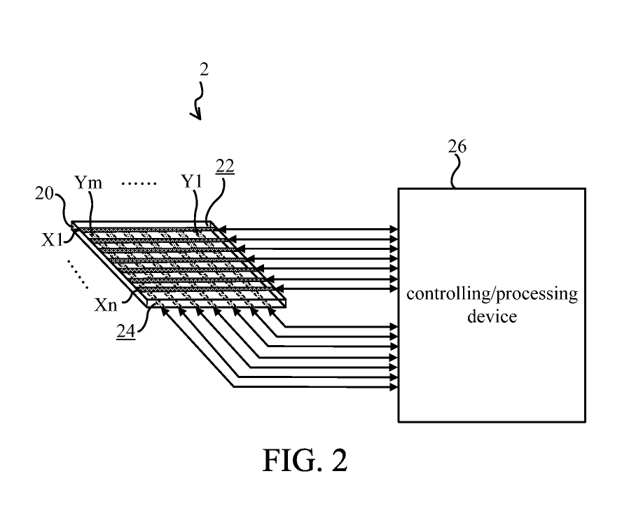

Referring to FIG. 2, FIG. 2 illustratively shows the architecture of a capacitive touch panel 2 according to a preferred embodiment of the invention.

As shown in FIG. 2, the capacitive touch panel 2 according to the invention includes a dielectric base 20, N first electrodes (X1˜Xn), M second electrodes (Y1˜Ym) and a controlling/processing device 26, where N and M respectively are an integer larger than 1.

The N first electrodes (X1˜Xn) are formed on a first surface 22 of the dielectric base 20, and extend along a first direction. The M second electrodes (Y1˜Ym) are formed on a second surface 24 of the dielectric base 20 opposite to the first surface 22, and extend along a second direction non-parallel with the first direction. For example, as shown in FIG. 2, the M second electrodes (Y1˜Ym), extending along the second direction, are perpendicular to the N first electrodes (X1˜Xn) extending along the first direction.

Also as shown in FIG. 2, the controlling/processing device 26 is respectively electrically connected to a respective end of each first electrode (X1˜Xn) and to a respective end of each second electrode (Y1˜Ym). The other end of each first electrode (X1˜Xn) and the other end of each second electrode (Y1˜Ym) all are in an open circuit state.

Distinguishable from the prior art, the controlling/processing device 26 simultaneously outputs a first frequency signal to each first electrode (X1˜Xn), and simultaneously outputs a second frequency signal to each second electrode (Y1˜Ym). The controlling/processing device 26 also monitors a respective third frequency signal outputted by each first electrode (X1˜Xn) and a respective fourth frequency signal outputted by each second electrode (Y1˜Ym). The controlling/processing device 26 also judges at least one touch coordinate in accordance with the monitored third frequency signals and the monitored fourth frequency signals.

In one embodiment, the controlling/processing device 26 monitors a respective first discharge period relative to each third frequency signal and a respective second discharge period relative to each fourth frequency signal. The controlling/processing device 26 also judges the at least one touch coordinate in accordance with the monitored first discharge periods and the monitored second discharge periods.

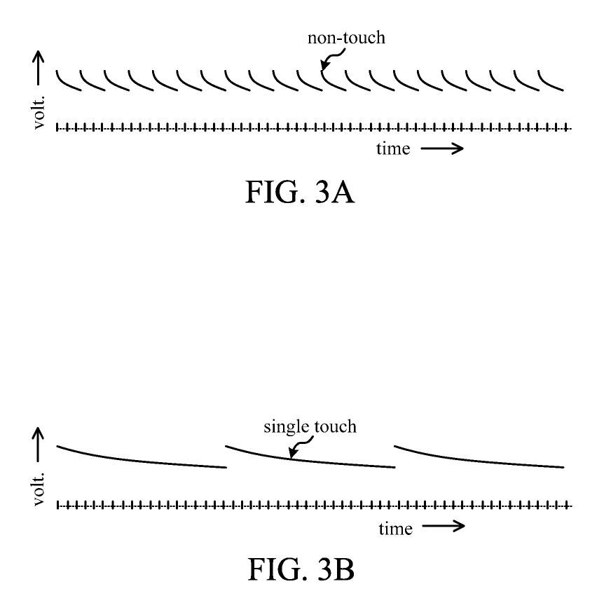

Referring to FIG. 3A and FIG. 3B, these diagrams show the monitored frequency signals outputted by electrodes of the capacitive touch panel applied by the invention. FIG. 3A shows the frequency signals monitored by the controlling/processing device 26 under non-touch. FIG. 3B shows the frequency signals monitored by the controlling/processing device 26 under single touch. Obviously, discharge periods of the frequency signals in FIG. 3B are much longer than those of frequency signals in FIG. 3A. In practice, discharge periods of the frequency signals monitored under double touch and multi-touch are shorter than those of the frequency signals monitored under single touch, but are longer than those of the frequency signals monitored under non-touch and longer enough that discharge periods of the frequency signals monitored under double touch and multi-touch can be identified.

In practical application, using aforesaid characteristics of discharge period variety of the monitored frequency signals outputted by the electrodes of the capacitive touch panel 2 under non-touch, double touch and multi-touch, the controlling/processing device 26 judges the at least one touch coordinate by whether the monitored first discharge periods and the monitored second discharge periods are longer than a threshold. That is to say, the controlling/processing device 26 simultaneously judges one among the first discharge periods and one among the second discharge periods that are longer than the threshold to determine the first electrode corresponding to such first discharge period and the second electrode corresponding to such second discharge period, and further to judge X-coordinate and Y-coordinate of the at least one touch coordinate. Thereby, the controlling/processing device 26 of the invention can implement multi-touch function.

With detailed description of the invention above, it is clear that the capacitive touch panel 2 of the invention prevents touch detecting circuit of the conventional capacitive touch panel, i.e., the capacitive touch panel 2 omits additional resistors and capacitors necessary for prior art. Therefore, the capacitive touch panel 2 of the invention can simplify circuit thereof, resist noise more, and be available for a variety of sizes of panel. In addition, the capacitive touch panel 2 of the invention charges the first electrodes (X1˜Xn) and the second electrodes (Y1˜Ym) at the same time such that the capacity effect is magnified to be detected easily more and to solve problem that a capacitive touch panel with large size can detect positions of tail end of electrodes thereof.

In addition, coordinate detection of the capacitive touch panel 2 of the invention utilizes parallel signal processing. Therefore, the response of touch detected by the capacitive touch panel 2 of the invention is rapid.

In one embodiment, the controlling/processing device 26 includes a complex programmable logic device (CPLD) or a micro-control unit (MCU). CPLD is a common parallel processor on market. It is noted that coordinate detection of the capacitive touch panel of prior art utilizes serial signal processing such that actual touch points are obtained necessarily by consumption of computation resources to prevent ghost touch points possibly generated. In fact, the multiple touch points applied by an operator are still one by one applied on the touch panel. The capacitive touch panel 2 of the invention utilizes parallel signal processing and frequency signals with high frequency to detect in time the multiple touch points which are applied on one by one. The capacitive touch panel 2 of the invention can detect one touch point less than 100 microseconds, detect multiple touch points more than ten at the same time, and be capable of tracking the touch points. Therefore, different from the prior art, the coordinate detection of the capacitive touch panel 2 of the invention cannot occur ghost touch points, and can enhance response speed of detecting touch.

In one embodiment, the dielectric base 20 is formed of a glass, an acrylic or other commercial transparent and dielectric material.

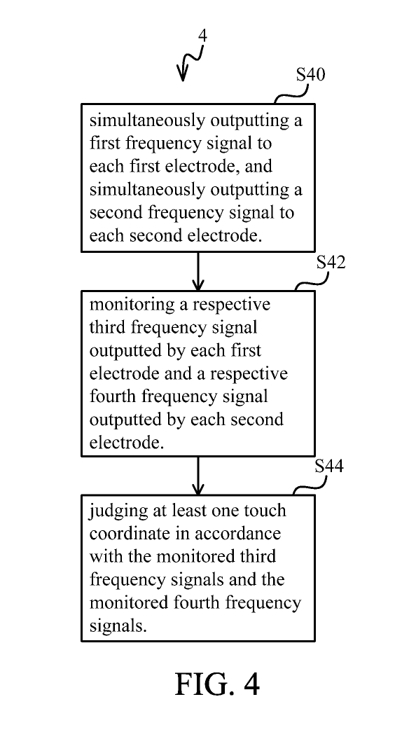

Referring to FIG. 4, FIG. 4 is a flow diagram illustrating a coordinate detecting method 4 according to a preferred embodiment of the invention. The coordinate detecting method 4 of the invention is applied in a capacitive touch panel such as the capacitive touch panel 2 as shown in FIG. 2. The capacitive touch panel includes a dielectric base, N first electrodes and M second electrodes, where N and M respectively are an integer larger than 1. N first electrodes are formed on a first surface of the dielectric base, and extend along a first direction. M second electrodes are formed on a second surface of the dielectric base opposite to the first surface and extending along a second direction non-parallel with the first direction.

As shown in FIG. 4, the coordinate detecting method 4 according to the invention, firstly, performs step S40 to simultaneously output a first frequency signal to each first electrode, and to simultaneously output a second frequency signal to each second electrode.

Next, the coordinate detecting method 4 performs step S42 to monitor a respective third frequency signal outputted by each first electrode and a respective fourth frequency signal outputted by each second electrode.

Finally, the coordinate detecting method 4 performs step S44 to judge at least one touch coordinate in accordance with the monitored third frequency signals and the monitored fourth frequency signals.

In one embodiment, step S42 is to monitor a respective first discharge period relative to each third frequency signal and a respective second discharge period relative to each fourth frequency signal. In practical application, step S44 is to judge the at least one touch coordinate by whether the monitored first discharge periods and the monitored second discharge periods are longer than a threshold. That is to say, step S44 is to simultaneously judge one among the first discharge periods and one among the second discharge periods that are longer than the threshold to determine the first electrode corresponding to such first discharge period and the second electrode corresponding to such second discharge period, and further to judge X-coordinate and Y-coordinate of the at least one touch coordinate.

In one embodiment, steps S40 to S44 all are performed by a complex programmable logic device or a micro-control unit. Referring to FIG. 2, the connection between the first electrodes, the second electrodes and the controlling/processing device is shown in FIG. 2, and it will not be described again here.

With the detailed description of the above preferred embodiments of the invention, it is clear to understand that the capacitive touch panel and coordinate detecting method thereof disclosed by the invention has advantages of simplified circuit, rapid response, availability for a variety of sizes of panel, etc. The capacitive touch panel and coordinate detecting method according to the invention can practice multi-touch function, and have capability of tracking touch points.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A capacitive touch panel, comprising:
a dielectric base;
N first electrodes, being formed on a first surface of the dielectric base and extending along a first direction, wherein N is an integer larger than 1;
M second electrodes, being formed on a second surface of the dielectric base opposite to the first surface and extending along a second direction non-parallel with the first direction, wherein M is an integer larger than 1; and
a controlling/processing device, respectively electrically connected to a respective end of each first electrode and to a respective end of each second electrode, for simultaneously outputting a first frequency signal to each first electrode, simultaneously outputting a second frequency signal to each second electrode, monitoring a respective third frequency signal outputted by each first electrode and a respective fourth frequency signal outputted by each second electrode, and judging at least one touch coordinate in accordance with the monitored third frequency signals and the monitored fourth frequency signals.

2. The capacitive touch panel of claim 1, wherein the controlling/processing device monitors a respective first discharge period relative to each third frequency signal and a respective second discharge period relative to each fourth frequency signal, and the controlling/processing device judges said at least one touch coordinate in accordance with the monitored first discharge periods and the monitored second discharge periods.

3. The capacitive touch panel of claim 2, wherein the controlling/processing device judges said at least one touch coordinate by whether the monitored first discharge periods and the monitored second discharge periods are longer than a threshold.

4. The capacitive touch panel of claim 1, wherein the controlling/processing device comprises a complex programmable logic device or a micro-control unit.

5. The capacitive touch panel of claim 1, wherein the dielectric base is formed of a glass or an acrylic.

6. A coordinate detecting method applied in a capacitive touch panel which comprises a dielectric base, N first electrodes and M second electrodes, N and M respectively being an integer larger than 1, N first electrodes being formed on a first surface of the dielectric base and extending along a first direction, M second electrodes being formed on a second surface of the dielectric base opposite to the first surface and extending along a second direction non-parallel with the first direction, said coordinate detecting method comprising the steps of:
(a) simultaneously outputting a first frequency signal to each first electrode, and simultaneously outputting a second frequency signal to each second electrode;
(b) monitoring a respective third frequency signal outputted by each first electrode and a respective fourth frequency signal outputted by each second electrode; and
(c) judging at least one touch coordinate in accordance with the monitored third frequency signals and the monitored fourth frequency signals.

7. The coordinate detecting method of claim 6, wherein step (b) is to monitor a respective first discharge period relative to each third frequency signal and a respective second discharge period relative to each fourth frequency signal.

8. The coordinate detecting method of claim 7, wherein step (c) is to judge said at least one touch coordinate by whether the monitored first discharge periods and the monitored second discharge periods are longer than a threshold.

9. The coordinate detecting method of claim 6, wherein step (a) to step (c) all are performed by a complex programmable logic device or a micro-control unit.
